(19) United States
(12) Patent Application Publication
(10) Pub. No.: US 2010/0216410 A1
(43) Pub. Date: Aug. 26, 2010

(54) RADIO TRANSCEIVER MODULE

(75) Inventors: I-Ru Liu, Taiwan (TW); Ting-I Tsai, Taiwan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: AICONN TECHNOLOGY CORPORATION, Taipei (TW)

(21) Appl. No.: 12/649,897

(22) Filed: Dec. 30, 2009

(30) Foreign Application Priority Data
Feb. 20, 2009 (TW) 098105557

(51) Int. Cl. H04B 1/38

(52) U.S. Cl. 455/73

(57) ABSTRACT

A radio transceiver module includes an interposer, a first wire routing layer, a second wire routing layer, a passive component and a wireless network chip. The interposer is provided with a first surface and an opposite second surface, and includes a plurality of through-holes. The first wire routing layer is configured on the first surface of the interposer, the second wire routing layer is configured on the second surface of the interposer, the passive component and the wireless network chip are configured on a surface of the first wire routing layer; whereas, the wireless network chip, the interposer and the passive component are electrically connected with one another.

### CROSS-REFERENCE TO RELATED APPLICATION

This application claims the benefit of Taiwan Patent Application No. 098105557, filed on Feb. 20, 2009, which is hereby incorporated by reference for all purposes as if fully set forth herein.

### BACKGROUND OF THE INVENTION

1. Field of the Invention

The present invention relates to a radio transceiver module, and more particularly to a radio transceiver module for System-in-Package (SiP) structure.

2. Description of the Prior Art

Radio transceiver module (such as a Wi-Fi module) includes a game station (application of internet games), a mobile phone (network phones and smart phones), a PDA (wireless internetworking, the sending and receiving of e-mails) and a personal audio-visual entertainment device. This kind of radio transceiver module can be installed in a laptop computer, a mobile networking device or a smart phone, and allows these electronic devices to conduct Bluetooth wireless transmission and to connect with a wireless network.

FIG. 1 shows a cross-sectional view of a conventional radio transceiver module, wherein the conventional radio transceiver module 10 includes a package substrate 100, a plurality of chips 110 with different functions attached on a surface of the package substrate 100, and an EMC (Epoxy Molding Compound) (not shown in the drawing). The chips 110 are assembled on the package substrate 100 using a surface mounted technology (SMT), and the conventional System-in-Package (SiP) structure also includes at least one passive component 120 that is attached on a bonding pad of the package substrate 100 to further connect electrically with the chips 110, thereby accomplishing a complete circuit design.

In general, the substrate of the radio transceiver module is usually made of a ceramic or organic material adopted by Low Temperature Cofired Ceramic (LTCC) such as Bismaleimide Triazine resin (BT resin) or glass epoxy resin (FR-4 resin). However, the LTTC substrate is normally formed by stacking 10 to 12 wire layers, whereas the organic substrate is usually formed by stacking 4 to 6 wire layers; these substrates having multiple wire layers occupies a certain space as well.

As the existing laptop computer, the mobile networking device and the smart phone are mostly developed toward a small size and thin thickness, to satisfy this development trend, the radio transceiver module 10 has to be developed toward miniaturization as well. Accordingly, how to reduce the size occupied by the radio transceiver module in the electronic device is an important issue.

### SUMMARY OF THE INVENTION

The primary object of the present invention is to provide a radio transceiver module to reduce a volume of an electronic device occupied by this module.

In order to achieve the above objective, the radio transceiver module is provided in the present invention, and includes an interposer, a first redistribution layer, a second redistribution layer, a passive component and a wireless network chip. The interposer is provided with a first surface and a second surface corresponding to each other, and includes a plurality of through-holes. The first redistribution layer is configured on the first surface of the interposer and has a plurality of first bond pads. The first bond pads are electrically connected to the through holes. The second redistribution layer is configured on the second surface of the interposer and has a plurality of second bondpads. The second bondpads are electrically connected to the through holes. The passive component and the wireless network chip are configured on a surface of the first redistribution layer. An interval is disposed between the wireless network chip and the passive component; whereas, the wireless network chip, the interposer and the passive component are electrically connected with one another.

In an embodiment of the present invention, the radio transceiver module further includes a plurality of first conducting bumps which are configured on surfaces of the first bondpads. Since the first conducting bumps are in contact with the passive component or the wireless network chip, the interposer is electrically connected to the passive component or the wireless network chip.

In an embodiment of the present invention, the radio transceiver module further includes a plurality of second conducting bumps which are configured on surfaces of the second bondpads.

The interposer is electrically connected to a printed circuit board when the second conducting bumps are in contact with the printed circuit board.

In an embodiment of the present invention, the first bondpads are made of a metal.

In an embodiment of the present invention, the second bondpads are made of a metal.

In an embodiment of the present invention, the interposer is made of silicon, silicon germanium or gallium arsenide.

In an embodiment of the present invention, the wireless network chip further includes an epoxy molding compound which is adhered on the first surface of the interposer and encapsulates the passive component and the wireless network chip to isolate the passive component and the wireless network chip from ambient environment.

In an embodiment of the present invention, the epoxy molding compound is made of silicon dioxide.

In an embodiment of the present invention, the passive component is selected from the group consisting of a capacitor, a resistor and an inductor.

With the conductor disposed in the through hole, the wireless network chip, the passive component and the interposer therefore can be assembled as a stacked body. When the interposer is a silicon substrate, circuits on the silicon substrate are denser than those on the ceramic or organic substrate to reduce the number of stacked layers on the substrate, thereby reducing the volume occupied by the wireless network chip, the passive component and the interposer.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cutaway view of a conventional radio transceiver module.

FIG. 2 shows a cutaway view of a radio transceiver module of the present invention.

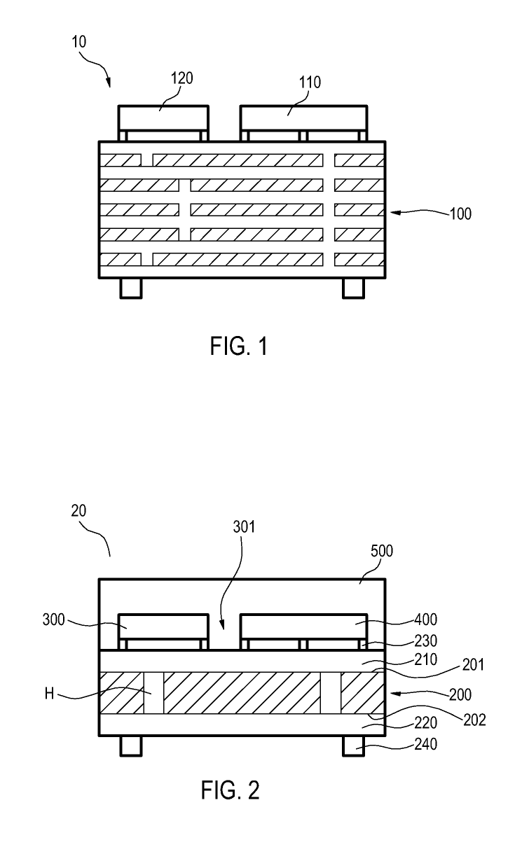

### DETAILED DESCRIPTION OF THE PREFERRED EMBODIMENTS

Referring to FIG. 2, it shows a cross-sectional view of a radio transceiver module of the present invention, wherein the radio transceiver module 20 comprises an interposer 200, a first redistribution layer 210, a second redistribution layer 220, a passive component 300 and a wireless network chip 400.

The substrate material of the interposer 200 can be silicon or silicon germanium, and the substrate materials of the passive component 300 and the wireless network chip 400 can be silicon or silicon germanium as well. Thus, the interposer 200, the passive component 300 and the wireless network chip 400 will have the same element: silicon. Therefore, when the passive component 300 or the wireless network chip 400 is configured on the interposer 200, the thermal expansion coefficient difference between the passive component 300 or the wireless network chip 400 and the interposer 200 is limited to prevent the radio transceiver module from being cracked due to the different the thermal expansion coefficient.

The interposer 200 is provided with a first surface 201 and a second surface 202 corresponding to one another, and further includes a plurality of through-holes H which can be TSV (Through-Silicon Vias) structures.

Since the hardness of the silicon substrate is different from that of a conventional ceramic or organic substrate, the manner to form the through-holes H on the interposer 200 will be obviously different from that on the ceramic or organic substrate. For example, one of the ordinary ways to form the through-holes H on the ceramic or organic substrate is mechanical drilling. Yet, as the hardness of the silicon substrate is high, it will not be able to use the mechanical drilling to form the through-holes H on the silicon substrate. However, there are still a lot of ways to form the through-holes H on the silicon substrate, such as a laser drilling process, where the laser used in the laser drilling process can be carbon dioxide laser or ultraviolet laser.

The through-hole H is configured with a conductor to form a conducting channel.

The conductor can be conducting glue, metallic copper or other proper material. With these conductors, the first redistribution layer 210, the interposer 200 and the second redistribution layer 220 are electrically connected with one another.

The interposer 200 includes a first pattern layer and a second pattern layer which are formed respectively at two sides of the interposer 200.

It needs to be mentioned particularly that when the interposer 200 is a silicon substrate or a silicon-germanium substrate, the method to form the pattern layer on the silicon or silicon-germanium substrate is significantly different from that on the ordinary ceramic or organic (e.g., resin) substrate. In other words, the ordinary manufacturing method to form the pattern layer on the ceramic or organic substrate cannot be directly carried out by directly replacing the ceramic or organic substrate with the silicon or silicon-germanium substrate. On the contrary, the manufacturing method to form the pattern layer on the silicon or silicon-germanium substrate cannot be used to process the ceramic or organic substrate either.

For example, as the dimension of the ordinary silicon or silicon-germanium substrate is 6″, 8″ or 12″ (inch), the dimension of the ordinary organic substrate is 508×508 mm, 508×610 mm or the size of other proper rectangle. When the pattern layer is to be formed on the silicon or silicon-germanium substrate, the processing environment must be designed specifically for this circular wafer and cannot be used for the ordinary ceramic or organic substrate.

On the other hand, the silicon or silicon-germanium substrate includes the element silicon. Hence, etchant, such as HF (Hydrogen Fluoride), used in forming the pattern layer on the silicon or silicon-germanium substrate is significantly different from the etchant (e.g., acid etchant or base etchant) used in the ceramic or organic substrate as well.

When the interposer 200 is a silicon or silicon-germanium substrate, the first pattern layer and the second pattern layer can be formed respectively on a front surface and a rear surface of the silicon or silicon-germanium substrate by coating, lithographing and etching. That is, this manner is similar to the ordinary manufacturing method to process a silicon wafer.

Accordingly, wire width of circuit laid out on the silicon or silicon-germanium substrate can be thinner than that on the ceramic or organic substrate, and only one layer of the circuit layout on the silicon or silicon-germanium substrate can achieve the requirement of multiple layers of the circuit layout on the ceramic or organic substrate, such that the space occupied by the radio transceiver module can be reduced, thereby satisfying the miniaturization trend.

The first redistribution layer 210 is configured on the first pattern layer, meaning that the first redistribution layer 210 is configured on the first surface 201 of the interposer 200.

The first redistribution layer 210 includes a first dielectric layer, a second dielectric layer and a first redistributive conducting layer. The first redistributive conducting layer is configured between the first dielectric layer and the second dielectric layer, and is provided with plural first bond pads; whereas, the second dielectric layer at least partially exposes the plural first bond pads of the first redistributive conducting layer. The first dielectric layer and the second dielectric layer can be made of PI (Polymeric Imides) or BCB (Benzocyclobutene).

Similarly, the second redistribution layer 220 is configured on the second pattern layer, meaning that the second redistribution layer 220 is configured on the second surface 202 of the interposer 200.

The second redistribution layer 220 includes a third dielectric layer, a fourth dielectric layer and a second redistributive conducting layer. The second redistributive conducting layer is configured between the third dielectric layer and the fourth dielectric layer and is provided with plural second bond pads; whereas the fourth dielectric layer at least partially exposes the plural second bond pads of the second redistributive conducting layer. The third dielectric layer and the fourth dielectric layer can be made of PI or BCB.

The passive component 300 can be a resistor, a capacitor, an inductor or their assembly thereof, and the wireless network chip 400 can be a chip for generating Wi-Fi radio signals. The passive component 300 and the wireless network chip 400 are configured respectively on the surface of the first redistribution layer 210. Therefore, the wireless network chip 400, the interposer 200 and the passive component 300 are electrically connected with one another. It is worthy of mentioning that there is a gap 301 between the wireless network chip 400 and the passive component 300. In fact, positions, quantities and specifications of the passive component 300 and the wireless network chip 400 are depends upon the circuit design.

The passive component 300 or the wireless network chip 400 can be configured on the surface of the first redistribution layer 210 by a surface mounted technology or plural conducting bumps. Since the passive component 300 or the wireless network chip 400 is in contact with these conducting bumps, the interposer 200 can be electrically connected to the passive component 300 or the wireless network chip 400.

For example, the radio transceiver module 20 of the embodiment includes a plurality of first conducting bumps 230 which can be plural solder blocks, and these solder blocks can be solder balls. These first conducting bumps 230 are configured on surfaces of the first bond pads of the first redistribution layer 210. Thus, the passive component 300 or the wireless network chip 400 can be electrically connected on the interposer 200 through these conducting bumps 230.

On the other hand, the foregoing radio transceiver module 20 further includes a plurality of second conducting bumps 240 which are configured on surfaces of the second bond pads of the second redistribution layer 220. These second conducting bumps 240 can be solder blocks which can be solder balls. As these second conducting bumps 240 are in contact with a circuit board, the interposer 200 can be electrically connected to a printed circuit board. The circuit board can be a motherboard in a laptop computer, a mobile networking device or a smart phone.

The foregoing radio transceiver module 20 further includes an EMC 500 which is configured on the first surface 201 of the interposer 200 and encapsulates the passive component 300 and the wireless network chip 400 to isolate the passive component 300 and the wireless network chip 400 from ambient environment and to enhance a package structure of the radio transceiver module 20. The aforementioned EMC 500 can be made of silicon dioxide (SiO2) or epoxy resin.

Accordingly, with the conductors in the through-holes H, the wireless network chip 400, the passive component 300 and the interposer 200 can be assembled as a stacked body. When the interposer 200 is the silicon or silicon-germanium substrate, the circuit layout on the silicon wafer is thinner than that on the ceramic or organic substrate. Only one layer of the circuit layout is needed to achieve an effect as well as the ceramic or organic substrate utilizing the multiple layers of the circuit layout and to further reduce the space occupied by the radio transceiver module 20, thereby satisfying the miniaturization trend.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A radio transceiver module comprising:
an interposer provided with a first surface and an opposite second surface, and having a plurality of through-holes;
a first redistribution layer configured on the first surface and having a plurality of first bond pads, the first bond pads electrically connected to the through-holes;
a second redistribution layer configured on the second surface and having a plurality of second bond pads, the second bonding pads electrically connected to the through-holes;
a passive component configured on a surface of the first redistribution layer; and
a wireless network chip configured on the surface of the first redistribution layer, a gap provided between the wireless network chip and the passive component, wherein the wireless network chip, the interposer and the passive component are electrically connected with one another.

2. The radio transceiver module according to claim 1, wherein the radio transceiver module further includes a plurality of first conducting bumps which are configured on surfaces of the first bondpads.

3. The radio transceiver module according to claim 2, wherein the interposer is electrically connected to the passive component or the wireless network chip when the first conducting bumps is in contact with the passive component or the wireless network chip.

4. The radio transceiver module according to claim 1, wherein the radio transceiver module further includes a plurality of second conducting bumps which are configured on surfaces of the second bond pads.

5. The radio transceiver module according to claim 4, wherein the interposer is electrically connected to a printed circuit board when the second conducting bumps is in contact with the printed circuit board.

6. The radio transceiver module according to claim 1, wherein the first bond pads are made of a metal.

7. The radio transceiver module according to claim 1, wherein the second bond pads are made pf a metal.

8. The radio transceiver module according to claim 1, wherein the interposer is made of silicon, silicon germanium or gallium arsenide.

9. The radio transceiver module according to claim 1, wherein the wireless network chip further includes an epoxy molding compound, which is adhered to the first surface of the interposer and encapsulates the passive component and the wireless network chip, so as to isolate the passive component and the wireless network chip from ambient environment.

10. The radio transceiver module according to claim 9, wherein the epoxy molding compound is made of silicon dioxide.

11. The radio transceiver module according to claim 1, wherein the passive component is selected from a group consisting of a capacitor, a resistor and an inductor.
